(19) United States
(12) Patent Application Publication
(10) Pub. No.: US 2025/0367641 A1
(43) Pub. Date: Dec. 4, 2025

(54) PROCESS FOR PREPARATION OF 2-D NANOSTRUCTURED SHEET BASED PHOTOCATALYST AND APPLICATION THEREOF

(71) Applicant: COUNCIL OF SCIENTIFIC AND INDUSTRIAL RESEARCH, New Delhi (IN)

(72) Inventors: Yatendra Singh CHAUDHARY, Bhubaneswar (IN); Niharika KUMAR, Bhubaneswar (IN); Rajashree Priyadarsini MISHRA, Bhubaneswar (IN)

(73) Assignee: COUNCIL OF SCIENTIFIC AND INDUSTRIAL RESEARCH, New Delhi (IN)

(21) Appl. No.: 18/874,398

(22) PCT Filed: Jun. 13, 2023
(86) PCT No.: PCT/IN2023/050556

§ 371 Date: Dec. 12, 2024

(30) Foreign Application Priority Data
Jun. 14, 2022 (IN) 202211034151

(51) Int. Cl. B01J 23/755; B01J 21/18; B01J 27/24; B01J 35/59; B01J 35/73; B01J 37/08; C01B 3/00

(52) U.S. Cl. CPC B01J 23/755; B01J 21/18; B01J 27/24; B01J 35/59; B01J 35/73; B01J 37/08; C01B 3/00; C01B 2203/066

(57) ABSTRACT

The present invention relates to a process of microwave assisted preparation of atomically dispersed Ni modified (2-D) nanostructured sheets based photocatalyst mpg-C₃NₓNi. More particularly, the present invention relates to the drastically enhanced solar hydrogen at the rate from 200000 μmolg⁻¹h⁻¹ to 1000000 μmolg⁻¹h⁻¹ under sunlight by the atomically dispersed Ni modified catalyst mpg-C₃NₓNi, depending upon its synthesis route without any significant loss in activity. The atomically dispersed Ni modified (2-D) nanostructured sheets based mpg-C₃NₓNi photocatalyst exhibit good stability, and is cost effective, providing excellent hydrogen generation production rate.

### FIELD OF THE INVENTION

The present invention relates to a process for preparation of (2-D) nanostructured sheets based atomically dispersed Ni modified catalyst mpg-C₃NₓNi by simple and low cost microwave assisted method. More particularly, the present invention relates to process for preparation of (2-D) nanostructured sheets based heterostructured photocatalysts with enhanced solar hydrogen at the rate ranging from 200000 μmolg⁻¹h⁻¹ to 1000000 μmolg⁻¹h⁻¹ under sunlight by the developed atomically dispersed Ni modified catalyst mpg-C₃NₓNi, depending upon its synthesis route.

### BACKGROUND OF THE INVENTION

Extensive research has been devoted over the last four decades in designing photocatalysts having maximum visible light absorption with appropriate band edge position for driving the H⁺/CO₂ reduction reaction ever since the first reports of photoelectrochemical H₂ generation and photochemical CO₂ reduction, where conventionally de-ionized water was used as the proton source and CO₂ was purged from the high pressure cylinder. However, overall efficiency was mainly governed by the charge carrier separation, stability, recyclability and overall costs are still nightmare to entrust them in practical use. The brief literature of processes reported in prior arts is described below.

Reference may be made to article by Y. Tang et al., Phys. Chem., 16, 25321, 2014, wherein graphene sheltering engineering onto TiO₂ nanotube array for perfect inhibition of CdS photocorrosion (RGO/CdS-TiO₂ NT) reported by a one-step electrodeposition method. CdS photocorrosion driven by both holes and radicals has been systematically investigated and identified. The RGO layer provides a perfect protection to CdS for loss of electrons. Reference may be made to article by A. Das et al., Procc. Nat. Acad. Sci., 110, 16716, 2013, wherein hydrogen-generating system using CdSe NCs with much less labile water-solubilizing capping agents reported. System, which is more durable, allows assessment of the activity of successful H₂-generating catalysts that had been established electrochemically or in a different photochemical system.

Reference may be made to article by H. Li, et al. Adv. Energy Mater., 1401077, 2014, wherein carbon quantum dots (CQDs)/Cu₂O heterostructure with a protruding structure is synthesized and found to offer highly efficient photocatalytic conversion of CO₂ to methanol under solar-light irradiation. The CQDs/Cu₂O photocatalyst exhibits excellent stability during the conversion process, which is attributed to the photoinduced electron transfer properties of the CQDs.

Reference may be made to review article by Shanshan Chen et al, Nat Rev Mater, 17050, 2017, wherein particulate photocatalysts for overall water splitting have been summarized and divulges that the solar to hydrogen generation efficiency (STH) lies only around 1% and thus has the greatest impact on hydrogen cost.

Reference may be made to article by X. Wang et al., J. Am. Chem. Soc., 131, 1680, 2019, wherein polymerization process for melon (“graphitic carbon nitride”), with the aim of improving its photocatalytic activity intrinsically reported. Reduction of the synthesis temperature leads to a mixture of the monomer melem and its higher condensates.

Reference may be made to article by S. Cao et al., J. Phys. Chem. Lett, 5, 2101, 2014, wherein the graphite like carbon nitride (g-C₃N₄) has been used for photocatalysis under visible light illumination. Polymeric semiconductor shows outstanding stability even up to 600° C. in air and in a wide range of chemical environments as well. Presence of tri-s-triazine skeletons connected via tertiary amines contributes to its robustness in thermal and chemical stability. Most importantly, its band gap of ca. 2.7 eV with an appropriate band energetics for both, water oxidation and proton/CO₂ reduction, make this an obvious choice for photocatalytic solar fuel generation under visible light. Despite having these attractive properties for photocatalysis, its application as a visible light photocatalyst is greatly hindered by its poor electron-hole separation efficacy and limited absorption in visible region (only up to 450 nm). Urea is the widely reported precursor, as the g-C₃N₄ obtained through polycondensation of urea possesses higher surface area with very low density and shows less light absorption in visible range as compared to that of the g-C₃N₄ obtained from other precursor, such as in a Chinese patent CN106076383A by Jiangnan University, wherein thiourea is used as a precursor.

Reference may be made to Chinese patent CN111036269A, wherein Ni modified Ni C/g-C₃N₄ composite photo-catalyst has been prepared using urea as a precursor. In another example, a Chinese patent CN112473717A by Dong et al., wherein Nickel modified-/functional graphite-phase carbon nitride composite has been synthesized and it exhibited hydrogen production rate up to 24557 μmolg⁻¹h⁻¹. Despite of these modifications, the hydrogen generation rate does not appear commercially viable and also have limited absorption in visible region (typical energy gap for g-C₃N₄ ranges from 2.7 to 2.75 eV).

Thus, keeping in view the drawbacks of the hitherto reported prior arts, there is a need to design robust, efficient and cost effective photocatalyst, to address said problems in the field.

### OBJECTIVE OF THE INVENTION

The main objective of the present invention is to provide a process for the formation of (2-D) nanostructured sheets based atomically dispersed Ni modified photocatalyst mpg-C₃NₓNi.

Another objective of the present invention is to provide atomically dispersed Ni modified (2-D) nanostructured sheets based catalyst mpg-C₃NₓNi by one pot microwave assisted route, which are simple operational procedure and low cost.

Yet another objective of the present invention is to provide atomically dispersed Ni modified (2-D) nanostructured sheets based photocatalyst mpg-C₃NₓNi, wherein microwave assisted method is less energy intensive and incurs reduced reaction time upto 10 to 30 minutes for the synthesis of heterostructured photocatalyst.

Yet another objective of the present invention is to provide a robust photocatalyst-atomically dispersed Ni decorated mpg-C₃NₓNi that exhibit drastically enhanced solar hydrogen at the rate from 200000 μmolg⁻¹h⁻¹ to 1000000 μmolg^{31 1}h⁻¹ under sunlight by the atomically dispersed Ni modified catalyst mpg-C₃NₓNi, depending upon its synthesis route.

Still another objective of the present invention is to demonstrate that the atomically dispersed Ni decorated mpg-C₃NₓNi exhibit potential for the efficient and viable solar H₂ generation and selective CO₂ conversion to CH₄.

### SUMMARY OF THE INVENTION

Additional features and embodiments of the present disclosure will better be understood through the techniques and other aspects of the disclosure. Other embodiments of the invention are described in detail herein and are considered a part of the claimed disclosure.

The present invention provides a facile synthesis of atomically dispersed Ni modified (2-D) nanostructured sheets based photocatalyst mpg-C₃NₓNi that exhibit efficient solar H₂ generation and CO₂ conversion to highly selective products CH₄, under simulated solar radiation and direct sunlight.

In an embodiment of the present invention, there is provided modification of two dimensional (2-D) nanostructured sheets with the 2-D nanocrystals to improve the charge separation of photogenerated charge carriers and eventually enhanced solar fuel generation.

In particular, two dimensional (2-D) nanostructured sheets, that are mesoporous nitrogen deficient C₃Nₓ (mpg-C₃Nx) ultrathin sheets prepared by thermal decomposition under inert atmosphere were functionalized by Ni by microwave synthesis route to form atomically dispersed Ni decorated catalyst (mpg-C3NxNi).

In an embodiment of the present invention, the developed 2-D heterostructured photo-catalysts exhibit enhanced solar hydrogen generation and selective CO₂ conversion to CH₄. Among these photocatalysts, the atomically dispersed Ni modified catalyst mpg-C₃NₓNi exhibit drastically enhanced solar hydrogen at the rate from 200000 μmolg⁻¹h⁻¹ to 1000000 μmolg⁻¹h⁻¹ under sunlight, depending upon its synthesis route.

In an embodiment of the present invention, wherein the formation of respective phase, hetero-structure, were characterized by X-ray diffraction (XRD), X ray Photoelectron Spectroscopy (XPS), UV-Vis diffuse reflection spectroscopy (UV-Vis DRS), Transmission electron Microscopy (TEM), Field emission Scanning Electron Microscopy (FESEM) and Raman Spectroscopy. The solar H₂ generation and CO₂ conversion (solar fuel generation) were investigated by PEC/photo-catalysis experiments using potentiostat and gas chromatography (GC). The efficacy of charge carrier separation and recombination were studied by steady state and time resolved photoluminescence spectrometer.

These and other features, aspects, and advantages of the present subject matter will be better understood with reference to the following description and appended claims. This summary is provided to introduce a selection of concepts in a simplified form. This summary is not intended to identify key features or essential features of the claimed subject matter, nor is it intended to be used to limit the scope of the claimed subject matter.

### BRIEF DESCRIPTION OF THE DRAWINGS

The invention has other advantages and features which will be more readily apparent from the following detailed description of the invention and the appended claims, when taken in conjunction with the accompanying drawings, in which:

FIG. 1 represents the x-ray diffraction (XRD) pattern of 0.15 mM, 0.30 mM, 0.60 mM Nickel modified mpg-C₃Nₓ, in accordance with an embodiment of the present disclosure.

FIG. 2 represents (a) transmission electron microscope (TEM) image and (b) Energy Dispersive X-Ray Analysis (EDX) pattern of mpg-C₃Nₓ, in accordance with an embodiment of the present disclosure.

FIG. 3 represents x-ray photoelectron spectroscopy (XPS) analysis (a) C and (b) N for the atomically dispersed Ni modified catalysts mpg-C₃Nx-Ni, in accordance with an embodiment of the present disclosure.

FIG. 4 represents the photoluminescence spectra for bare and Ni decorated mpg-C₃Nₓ, in accordance with an embodiment of the present disclosure.

FIG. 5 represents the Tauc plot of bare and Ni-decorated C₃Nₓ, showing energy gap values, in accordance with an embodiment of the present disclosure.

FIG. 6 represents the solar hydrogen generation of the atomically dispersed Ni modified catalyst mpg-C₃NₓNi under sunlight, in accordance with an embodiment of the present disclosure.

FIG. 7 represents solar hydrogen generation using the solar simulator as the light source for the 0.15 mM Solvo-Ni-mpg-C₃Nx (synthesized by solvothermal modification with Ni) and 0.15 mM Micro-Ni-mpg-C₃Nx (microwave assisted modification with Ni) in water with triethanolamine (TEOA) electron donor, in accordance with an embodiment of the present disclosure.

FIG. 8 represents the photocatalytic CO₂ reduction to CH₄ using the solar simulator as the light source for the 0.30 mM Solvo-Ni-mpg-C₃Nₓ (synthesized by solvothermal modification with Ni), in accordance with an embodiment of the present disclosure.

### DETAILED DESCRIPTION OF THE INVENTION

The foregoing detailed description of the disclosure is elaborated to provide a clear understanding to the person who is skilled in the art. Additional features, embodiments and advantages of the invention will be described hereinafter which form the subject of the claims of the disclosure, However, the set forth disclosure provide in the specification will best be understood in conjunction with the appended claims and figures as provide heretofore. It should be appreciated by those skilled in the art that the conception and specific embodiment disclosed may be readily utilized as a basis for modifying or designing other structures for carrying out the same purposes of the present disclosure. It should also be realized by those skilled in the art that such equivalent processes do not depart from the spirit and scope of the disclosure as set forth in the appended claims. It will be readily understood that the aspects of the present disclosure, as generally described herein, and illustrated in the figures, can be arranged, substituted, combined, and designed in a wide variety of different configurations, all of which are explicitly contemplated and make part of this disclosure.

While the invention has been disclosed with reference to certain embodiments, it will be understood by those skilled in the art that various changes may be made and equivalents may be substituted without departing from the scope of the invention. In addition, many modifications may be made to adapt to a particular situation or material to the teachings of the invention without departing from its scope.

Throughout the specification and claims, the following terms take the meanings explicitly associated herein unless the context clearly dictates otherwise. The meaning of “a”, “an”, and “the” include plural references. The meaning of “in” includes “in” and “on.” Referring to the drawings, like numbers indicate like parts throughout the views.

The term “at least one” is used to mean one or more and thus includes individual components as well as mixtures/combinations.

Throughout this specification, unless the context requires otherwise the word “comprise”, and variations such as “comprises” and “comprising”, will be understood to imply the inclusion of a stated element or step or group of element or steps but not the exclusion of any other element or step or group of element or steps.

The term “including” is used to mean “including but not limited to”. “including” and “including but not limited to” are used interchangeably.

All percentages, parts and ratios are based upon the total weight of the compositions of the present disclosure unless otherwise indicated. Ratios, concentrations, amounts, and other numerical data may be presented herein in a range format. It is to be understood that such range format is used merely for convenience and brevity and should be interpreted flexibly to include not only the numerical values explicitly recited as the limits of the range, but also to include all the individual numerical values or sub-ranges encompassed within that range as if each numerical value and sub-range is explicitly recited. For example, a temperature range of 40 to 60° C. should be interpreted to include not only the explicitly recited limits of 40 to 60° C., but also to include sub-ranges, such as 40 to 50° C., 55 to 59° C. and so forth, as well as individual amounts, including fractional amounts, within the specified ranges, such as 44.5° C., 56.6° C. for example.

Unless defined otherwise, all technical and scientific terms used herein have the same meaning as commonly understood by one of ordinary skill in the art to which this disclosure belongs. Although any methods and materials similar or equivalent to those described herein can be used in the practice or testing of the disclosure, the preferred methods and materials are now described. All publications mentioned herein are incorporated herein by reference.

Additionally, a reference to the singular includes a reference to the plural unless otherwise stated or inconsistent with the disclosure herein. In line with the above objectives, the present invention provides a facile process for synthesizing atomically dispersed Ni modified catalyst mpg-C₃Nₓ—Ni by a single pot modification by microwave treatment of mpg-C₃Nₓ mixed with Ni precursor at 150° C. from 10 minutes to 30 minutes. The nitrogen deficient mesoporous carbon nitride (mpg-C₃Nₓ) synthesized using the rational choice of uncommon precursor (cynamide), and introduced porosity using Ludox as template, and nitrogen deficiency by heating under controlled atmosphere.

The present invention developed a nitrogen deficient mesoporous carbon nitride (mpg-C₃Nₓ) photocatalyst, which has been synthesized using the rational choice of uncommon precursor, and introduced porosity using Ludox as template, and nitrogen deficiency by heating under controlled atmosphere to drive solar to chemical fuel (H₂ and CH₄) generation. Further modification of mpg-C₃Nₓ with Ni has been undertaken by microwave route to form atomically dispersed Ni decorated catalysts (mpg-C₃NₓNi) which exhibit drastic enhancement in the solar H₂ generation activity. The light harvesting upon this modification has also been enhanced as the energy gap has reduced to 2.43 eV, from the typical value for g-C₃N₄ of 2.75 eV.

The present invention provides a process for the microwave assisted preparation of atomically dispersed Ni modified (2-D) nanostructured sheets based photocatalyst (mpg-C₃NₓNi) wherein x is in a range of 3 to 4, exhibiting solar hydrogen at the rate ranging from 200000 μmolg⁻¹h⁻¹ to 1000000 μmolg⁻¹h⁻¹ under sunlight, comprising the steps of:
i. adding carbon and nitrogen source (precursor) species in a Ludox solution to obtain the reaction precursor with the concentration ratio of 2:3 to 2:6;
ii. adding etchant ammonium hydrogen difluoride with the concentration ranging from 2-5 M to the reaction precursor for removing the Ludox template used to incorporate microporosity followed by washing to obtain mesoporous mpg-C₃Nx;
iii. adding Nickel source (precursor) species at different concentrations (in the range of 0.15 mM to 0.60 mM) in ethylene glycol and subsequently to the product obtained at step (iii) wherein the Ni concentration in a range of 2 to 10% with respect to weight of in the mesoporous mpg-C₃Nₓ to obtain a first mixture;

iv. adding sodium hydroxide with a hydrazine source in a volume ratio in a range of 1:30 to 1:300 into the first mixture and allowing to reflux at 65° C. for 5 hours to obtain a reaction mixture; and
v. microwave heat treatment of the solution as obtained in step (iv) for a period in the range of 10 minutes to 30 minutes at a temperature in a range of 120-150° C. to obtain atomically dispersed Ni modified mpg-C₃Nₓ.

In another approach, stock solutions of Nickel chloride hexahydrate (NiCl₂·6H₂O) were prepared using different concentrations (e.g., 0.15 mM to 0.60 mM) in ethylene glycol and as-synthesized mpg-C₃Nₓ and subjected to reflux for 3 hours while stirring. It was then mixed with hydrazine (different amount ranging from 4 μL to 19 μL) in aqueous NaOH solution allowed to age at 65° C. for 2 hours while stirring. Nickel nanocrystals modified mpg-C₃Nₓ were washed and centrifuged repeatedly with ethanol and dried overnight at 60° C. The formation of atomically dispersed Ni modified catalyst mpg-C₃Nₓ was confirmed by the XRD and XPS. The atomically dispersed Ni modified catalyst mpg-C₃Nₓ—Ni exhibits drastically enhanced solar hydrogen at a rate of up to 300000 μmolg⁻¹h⁻¹ under sunlight.

The present invention provides formation of atomically dispersed Ni modified catalyst mpg-C₃Nₓ—Ni, synthesized by varying concentration of Ni precursor (NiCl₂·6H₂O) from 0.30 to 1.2 g.

The present invention provides the solar hydrogen generation using the atomically dispersed Ni modified catalyst mpg-C₃Nₓ—Ni, undertaken using different amount of the photocatalysts (mpg-C₃NₓNi) [3 to 5 mg]

The solar hydrogen generation using the atomically dispersed Ni modified catalyst mpg-C₃Nₓ—Ni is undertaken with and without using the electron donors (DI water, TEA, TEOA etc.)

The present invention provides a simple, low cost and one pot process for the formation of mpg-C₃Nₓ—Ni, exhibiting excellent solar hydrogen at the rate ranging from 200000 μmolg⁻¹h⁻¹ to 1000000 μmolg⁻¹h⁻¹ under sunlight, depending upon photocatalyst synthesis route. It is very stable and exhibit continuous solar hydrogen generation for days (4) without any significant loss in activity.

The present invention provides a process for preparation of mpg-C₃Nₓ—Ni as disclosed herein, wherein said catalyst is useful to develop the renewable hydrogen generation device using the solar radiation.

The present invention provides a process for preparation of mpg-C₃Nₓ—Ni as disclosed herein, wherein said catalyst is useful to develop the renewable hydrogen generation device that can run the mini fan using the hydrogen fuel cell under direct sunlight, when the fuel cell is provided hydrogen being produced therein.

Although the present disclosure has been described in considerable detail with reference to certain embodiments and implementations thereof, other embodiments are possible to cover the modifications and variations of the present disclosure.

### EXAMPLES

The following examples, which include preferred embodiments, will serve to illustrate the practice of this invention, it being understood that the particulars shown are by way of example and for purpose of illustrative discussion of preferred embodiments of the invention.

### Example 1: Process for the Preparation of Nanocrystals Modified (2-D) Nanostructured Sheets Based Heterostructured Photocatalysts and the Atomically Dispersed Ni Modified Catalyst mpg-C₃NₓNi

The present example provides a facile process for synthesizing single site catalyst mpg-C₃Nₓ—Ni by a single pot modification by microwave treatment of mpg-C₃Nₓ mixed with Ni precursor at 150° C. from 10 minutes to 30 minutes. The nitrogen deficient mesoporous carbon nitride (mpg-C₃Nₓ) was synthesized by adding the rational choice of uncommon carbon and nitrogen source precursor cyanamide (12 g), in Ludox solution (15 ml, HS-40, 40 wt %) as template to introduce porosity. Nitrogen deficiency was created by heating under controlled atmosphere to obtain a reaction precursor. The Ludox template used to introduce microporosity was removed by adding etchant ammonium hydrogen difluoride with the concentration ranging from 2-5 M to the reaction precursor followed by washing to obtain a mesoporous mpg-C₃Nx.

### Example 2

To 20 ml of ethylene glycol, 0.144 g of Nickel (II) chloride (NiCl₂·6H₂O) was added and sonicated for 30 minutes to obtain a homogeneous mixture. To the homogeneous mixture, 0.06 g of mpg-C₃Nₓ was added and kept in microwave set at 150° C. for 10 minutes to obtain a solution. To this solution, 19 μL of hydrazine monohydrate and 600 μl of 1M NaOH were added. The resulting sediment was repeatedly washed and centrifuged with DI (deionized) water followed by drying at 60° C. The proportion of Ni in the Ni@mpg-C₃Nₓ catalyst synthesis was about 0.60 mM.

### Example 3

To 20 ml of ethylene glycol, 0.144 g of Nickel (II) Chloride (NiCl₂·6H₂O) was added and sonicated for 30 minutes to obtain a homogeneous mixture. To the homogeneous mixture, 0.06 g of mpg-C₃Nₓ was added and kept in microwave set at 150° C. for 10 minutes. To that solution, 16 μL of Hydrazine monohydrate and 600 μl of 1M NaOH were added. The resulting sediment was repeatedly washed and centrifuged with DI water followed by drying at 60° C. The proportion of Ni in the Ni@mpg-C₃Nₓ catalyst synthesis was about 0.60 mM.

### Example 4

To 20 ml of ethylene glycol, 0.72 g of Nickel (II) Chloride (NiCl₂·6H₂O) was added and sonicated for 30 minutes to obtain a homogeneous mixture. To the homogeneous mixture, 0.06 g of mpg-C₃Nₓ was added and kept in microwave set at 150° C. for 10 minutes. To this solution, 8 μL of Hydrazine monohydrate and 600 μl of 1M NaOH were added to obtain a reaction mixture and allowed to reflux at 65° C. for 5 hours. The resulting sediment was repeatedly washed and centrifuged with DI water and kept for drying at 60° C. The proportion of Ni in the Ni@mpg-C₃Nₓ catalyst synthesis was about 0.30 mM.

### Example 5

To 20 ml of ethylene glycol, 0.72 g of Nickel (II) Chloride (NiCl₂·6H₂O) was added and sonicated for 30 minutes to obtain a homogeneous mixture. To the homogeneous mixture, 0.06 g of (mpg-C₃Nₓ)—was added and kept in microwave set at 150° C. for 20 minutes. To this solution, 8 μl of Hydrazine monohydrate and 600 μl of 1M NaOH were added. The resulting sediment was repeatedly washed and centrifuged with DI water followed by drying at 60° C. The proportion of Ni in the Ni@mpg-C₃Nₓ catalyst synthesis was about 0.30 Mm.

### Example 6

To 20 ml of ethylene glycol, 0.36 g of Nickel (II) Chloride (NiCl₂·6H₂O) was added and sonicated for 30 minutes to obtain a homogeneous mixture. To the homogeneous mixture, 0.06 g of (mpg-C₃Nₓ) was added and kept in microwave set at 150° C. for 10 minutes. To this solution, 4 μL of Hydrazine monohydrate and 600 μl of 1M NaOH were added. The resulting sediment was repeatedly washed and centrifuged with DI water followed by drying at 60° C. The proportion of Ni in the Ni@mpg-C₃Nₓ catalyst synthesis was about 0.15 mM.

### Example 7

To 20 ml of ethylene glycol, 0.18 g of Nickel (II) Chloride (NiCl₂·6H₂O) was added and sonicated for 30 minutes to obtain a homogeneous mixture. To the homogeneous mixture, 0.06 g of (mpg-C₃Nₓ) was added and kept in microwave set at 150° C. for 10 minutes. To this solution, 4 μL of Hydrazine monohydrate and 600 μl of 1M NaOH were added. The resulting sediment was repeatedly washed and centrifuged with DI water followed by drying at 60° C. The proportion of Ni in the Ni@mpg-C₃Nₓ catalyst synthesis was about 0.15 mM.

In another approach, stock solutions of Nickel chloride hexahydrate (NiCl₂·6H₂O) were prepared using different concentrations (e.g., 0.15 mM to 0.60 mM) in ethylene glycol and as-synthesized mpg-C₃Nₓ. The stock solutions were subjected to reflux for 3 hours while stirring. It was then mixed with hydrazine (different amounts ranging from 4 μL to 19 μL) in aqueous NaOH solution and allowed to age at 65° C. for 2 hours while stirring. Nickel nanocrystals modified mpg-C₃Nₓ were washed and centrifuged repeatedly with ethanol. Finally, these were dried overnight at 60° C.

Example 8

To obtain a homogenous mixture, 0.144 g of Nickel (II) Chloride was added to 20 ml of ethylene glycol and stirred for 30 minutes. After adding 0.06 grams of (mpg-C₃Nₓ) to the homogenous mixture, it was allowed to stir at a temperature of 60° C. for 3 h. It was then mixed with hydrazine followed by which 19 μl of hydrazine monohydrate and 600 μl of 1M NaOH were added to the solution. Nickel nanocrystals modified mpg-C₃Nₓ were washed and centrifuged repeatedly with ethanol and dried overnight at 60° C. The proportion of Ni in the mpg-C₃Nₓ catalyst synthesis was about 0.60 mM.

### Example 9

To obtain a homogenous mixture 0.72 g of Nickel (II) Chloride was added to 20 ml of ethylene glycol and stirred for 30 minutes. After adding 0.06 grams of (mpg-C₃Nₓ) to the homogenous mixture, it was allowed to stir at a temperature of 60° C. for 3 h. To this solution 8 μl of hydrazine monohydrate and 600 μl of 1M NaOH were added. Nickel nanocrystals modified mpg-C₃Nₓ were washed and centrifuged repeatedly with ethanol and dried overnight at 60° C. The proportion of Ni in the mpg-C₃Nₓ catalyst synthesis was about 0.30 mM.

### Example 10

To obtain a homogenous mixture 0.36 g of Nickel (II) Chloride was added to 20 ml of ethylene glycol and stirred for 30 minutes. After adding 0.06 grams of (mpg-C₃Nₓ) to the homogenous mixture, it was allowed to stir at a temperature of 60° C. for 3 h. It was then mixed with 4 μl of hydrazine monohydrate and 600 μl of 1M NaOH were added. Nickel nanocrystals modified mpg-C₃Nₓ were washed and centrifuged repeatedly with ethanol and were dried overnight at 60° C. The proportion of Ni in the mpg-C₃Nₓ catalyst synthesis was about 0.30 mM.

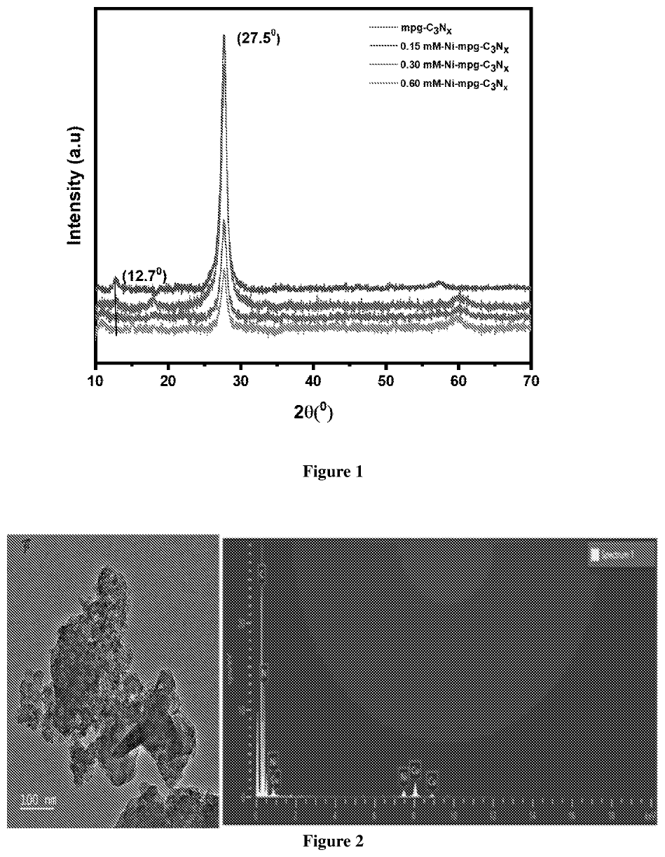

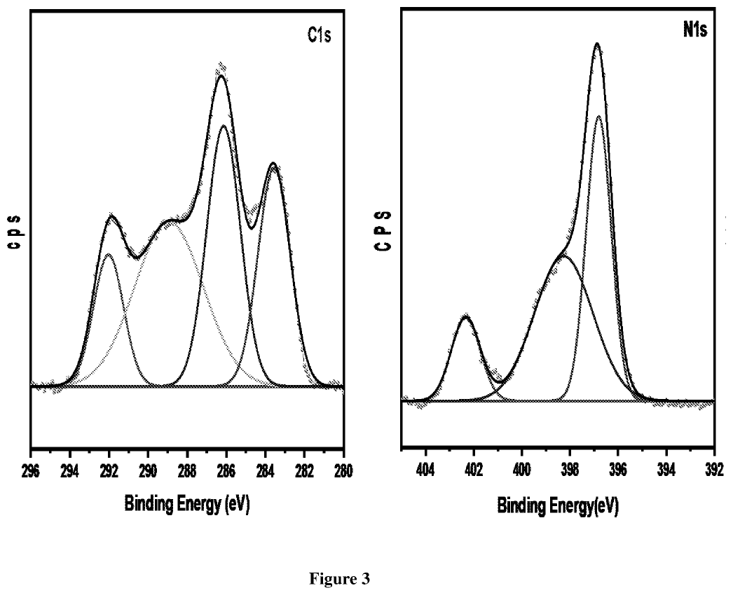

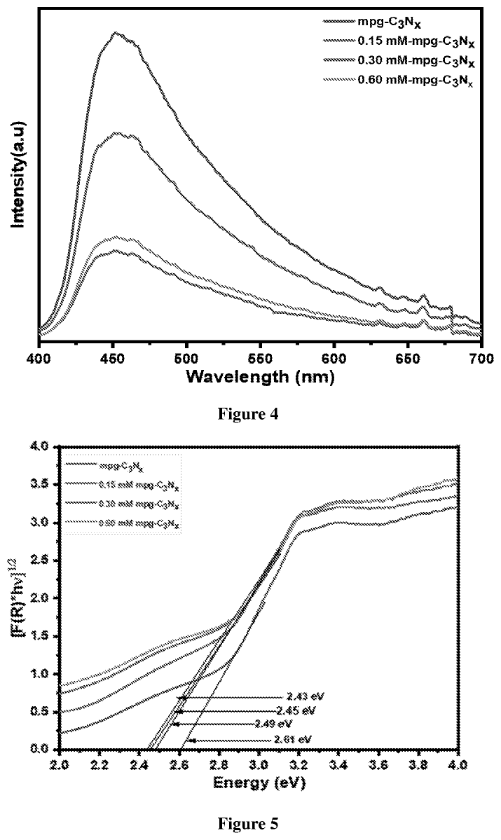

Characterization of the Nickel modified mpg-C₃Nₓ was carried out using x-ray diffraction (XRD) to analyse the formation of phase and crystallinity as shown in FIG. 1. The mpg-C₃Nₓ samples were analyzed using transmission electron microscope (TEM) for morphological analysis, and energy-dispersive x-ray spectroscopy (EDX) to understand the presence of elements through atomic analysis which is shown in FIG. 2. X-ray photoelectron spectroscopy (XPS) was carried out on the catalysts for analyzing the elemental composition, their concentration and oxidation states of Carbon (a) and Nitrogen (b) that is depicted in FIG. 3. The charge carrier dynamics studies of the catalyst samples were carried out via photoluminescence spectra shown in FIG. 4. Also, the energy gap values of the bare and Ni-decorated C₃Nₓ were analyzed using Tauc plot shown in FIG. 5.

### Example 11

### Solar Hydrogen Generation by the Synthesized Atomically Dispersed Ni Modified Catalyst mpg-C₃NₓNi

The atomically dispersed Ni modified catalyst mpg-C₃NₓNi exhibited drastically enhanced solar hydrogen at the rate ranging from 200000 μmolg⁻¹h⁻¹ to 1000000 μmolg⁻¹h⁻¹ under sunlight, depending upon the synthesis route of photocatalysts.

### Example 12

The prepared catalyst was subjected to hydrogen generation using solar simulator as a light source, and the method specifically comprised the following steps:

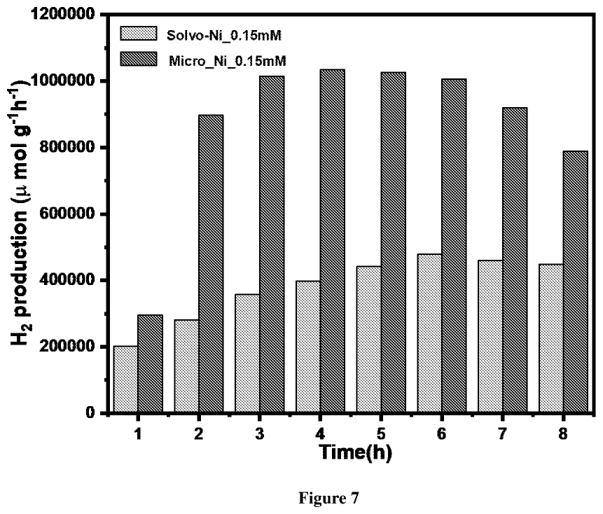

About 3 mg of the atomically dispersed Ni modified catalyst mpg-C₃Nₓ was weighed, followed by adding in a photocatalytic reactor. Subsequently, 5 ml of water was added to the reactor (or in other case 4.5 ml water and then 0.5 ml electron donor from the group of triethylamine (TEA) and triethanolamine (TEOA)). The solution was then subjected to stirring at room temperature, degassing with nitrogen for 30 minutes to remove dissolved oxygen from the photocatalytic reactor was exposed to the solar simulator (equipped with AM 1.5 filter). The hydrogen production was measured at the interval of every 1 hour using the Gas Chromatograph equipment. The solar hydrogen generation using the solar simulator as the light source for the 0.15 mM Solvo-Ni-mpg-C₃Nₓ (synthesized by solvothermal modification with Ni) and 0.15 mM Micro-Ni-mpg-C₃Nₓ (microwave assisted modification with Ni) in water with TEOA electron donor, are comparatively shown in FIG. 7.

### Example 13

In another example, the prepared catalyst was subjected to hydrogen generation under the direct sunlight, and the method specifically comprised the following steps:

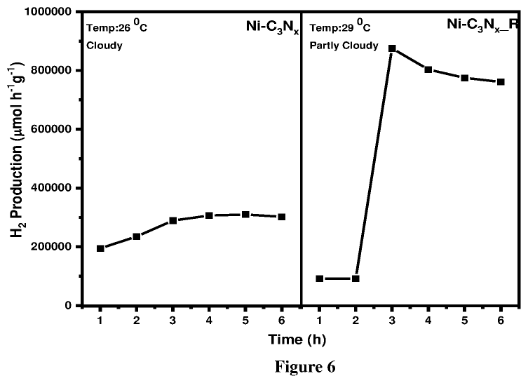

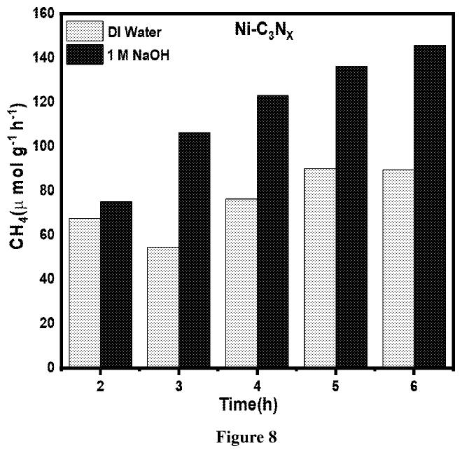

3 mg of the atomically dispersed Ni modified catalyst mpg-C₃Nₓ was weighed, followed by addition to a photocatalytic reactor. Subsequently, water was added and then an electron donor to obtain a mixture. The mixture was then stirred at room temperature, degassing with nitrogen for 30 minutes to remove dissolved oxygen from the photocatalytic reactor followed by exposing it to the direct sunlight (sunlight), and measuring the hydrogen production at the interval of every 1 hour using the Gas Chromatograph equipment. The solar hydrogen generation of the atomically dispersed Ni modified catalyst mpg-C₃NₓNi under sunlight was analysed and shown in FIG. 6. Further, the photocatalytic CO₂ reduction to CH₄ using the solar simulator as the light source for the 0.30 mM Solvo-Ni-mpg-C₃Nₓ (synthesized by solvothermal modification with Ni) was analyzed and depicted in FIG. 8.

### ADVANTAGES OF THE INVENTION

Process for the preparation of atomically dispersed Ni modified (2-D) nanostructured sheets based catalyst mpg-C₃NₓNi by microwave assisted route having one pot, simple synthetic procedure and low operational cost.

The formation of atomically dispersed Ni modified catalyst mpg-C₃NₓNi by microwave route is fast (reaction duration 10 minutes) and less energy intensive. The developed 2-D nanostructured sheets based heterostructured photocatalysts comprises Earth abundant elements and thus are inexpensive.

The developed atomically dispersed Ni modified catalyst mpg-C₃NₓNi exhibit drastically enhanced solar hydrogen at the rate from 200000 μmolg⁻¹h⁻¹ to 1000000 μmolg⁻¹h⁻¹ under sunlight by the atomically dispersed Ni modified catalyst mpg-C₃NₓNi, depending upon its synthesis route.

The atomically dispersed Ni modified catalyst mpg-C₃Nₓ—Ni catalysts is useful to develop the renewable hydrogen generation device using the solar radiation that run the mini fan using the hydrogen fuel cell under direct sunlight, when the fuel cell is provided hydrogen being produced therein.

We claim:

1. A process for microwave assisted preparation of atomically dispersed Ni modified (2-D) nanostructured sheets based photocatalyst (mpg-C₃NₓNi) wherein x is in a range of 3 to 4, exhibiting solar hydrogen at the rate ranging from 200000 μmolg⁻¹h⁻¹ to 1000000 μmolg⁻¹h⁻¹ under sunlight, comprising the steps of:
i. adding carbon and nitrogen source (precursor) species in a Ludox solution to obtain a reaction precursor with the concentration ratio of 2:3 to 2:6;
ii. adding etchant ammonium hydrogen difluoride with the concentration ranging from 2-5 M to the reaction precursor for removing the Ludox template followed by washing to obtain a mesoporous mpg-C₃Nx;
iii. adding Nickel source (precursor) species at different concentrations (in the range of 0.15 mM to 0.60 mM) in ethylene glycol and subsequently to the product obtained at step (ii) wherein Ni concentration is in a range of 2 to 10% with respect to mesoporous mpg-C₃Nₓ to obtain a first mixture;
iv. adding sodium hydroxide with a hydrazine source in a volume ratio in a range of 1:30 to 1:300 into the first mixture and allowing to reflux at 65° C. for 5 hours to obtain a reaction mixture; and
v. microwave heat treatment of the solution as obtained in step (iv) for a period in a range of 10 minutes to 30 minutes at a temperature in a range of 120-150° C. to obtain the atomically dispersed Ni modified mpg-C₃Nₓ—Ni.

2. The process for preparation of mpg-C₃Nₓ—Ni as claimed in claim 1, wherein the carbon and nitrogen source is selected from the group consisting of urea, melamine and cyanamide.

3. The process for preparation of mpg-C₃Nₓ—Ni as claimed in claim 1, wherein the Ni source is selected from the group consisting of nickel nitrate, and nickel tetrachloride.

4. The process for preparation of mpg-C₃Nₓ—Ni as claimed in claim 1, wherein said photocatalysts exhibit enhanced hydrogen generation, and is tunable by changing electron donors selected from the group consisting of triethylamine (TEA), and triethanolamine (TEOA).

5. The process for preparation of mpg-C₃Nₓ—Ni as claimed in claim 1, wherein said catalyst is useful to develop a renewable hydrogen generation device using solar radiation.
